(19) United States
(12) Patent Application Publication
(10) Pub. No.: US 2014/0005957 A1
(43) Pub. Date: Jan. 2, 2014

(54) VISCOMETER FOR NEWTONIAN AND NON-NEWTONIAN FLUIDS

(71) Applicant: Roger Kenneth Pihlaja, Spring Park, MN (US)

(72) Inventor: Roger Kenneth Pihlaja, Spring Park, MN (US)

(73) Assignee: ROSEMOUNT INC., Chanhassen, MN (US)

(21) Appl. No.: 13/538,488

(22) Filed: Jun. 29, 2012

(51) Int. Cl. G01N 11/08; G06F 19/00

(52) U.S. Cl. 702/50

(57) ABSTRACT

A viscometer comprises a plurality of capillary tubes connected in series with a mass flow meter. The capillary tubes are smooth, straight, and unimpeded, and each has a different known, constant diameter. Differential pressure transducers sense differential pressure across measurement lengths of each capillary tube, and the mass flow meter senses fluid mass flow rate and fluid density. A data processor connected to the mass flow meter and the differential pressure transducers computes viscosity parameters of fluid flowing through the viscometer using non-Newtonian fluid models, based on the known, constant diameters and measurement lengths of each capillary tube, the sensed differential pressures across each measurement length, the fluid mass flow rate, and the fluid density.

### BACKGROUND

The present invention relates generally to viscosity measurement, and more particularly to a viscometer capable of handling both Newtonian and non-Newtonian fluids.

Fluid viscosity is a critical and commonly measured parameter in many industrial processes. A variety of viscometer designs are used in such processes, typically by diverting a small quantity of process fluid from a primary process flow path through a viscometer connected in parallel with the primary process flow path. A few in-line designs instead allow viscometers to be located directly in the primary flow path, obviating the need to divert process fluid. Most conventional industrial viscometers utilize rotating parts in contact with process fluids, and consequently require bearings and seals to prevent fluid from leaking. In applications involving harsh, corrosive or abrasive fluids, such viscometers may require frequent maintenance.

Conventional industrial process viscometers are well-suited to measuring Newtonian fluids (wherein viscosity is constant). A wide range of industrial applications, however, handle slurries, pastes, and plastics which behave in a non-Newtonian fashion, and which conventional viscometers are not equipped to measure. Such industrial applications include oil field drilling (e.g. handling drilling mud), paste or plastic manufacture (e.g. handling cosmetics or polymers, or building products such as paint, plaster, or mortar), refining (e.g. handling lube or fuel oil), and food processing.

The viscosity of Newtonian fluids in Couette flow (i.e. flow between two parallel plates, one of which is moving relative to the other) is described by:

$$\frac{F}{A} = τ = - μ \frac{d u}{d y} \qquad [ Equation 1 ]$$

where F is shear force, A is the cross-sectional area of each plane, τ is shear stress (or equivalently momentum flux), μ is viscosity, and du/dy is shear rate. Extrapolating from this formula yields the following relation between shear stress, shear rate, and viscosity within a tube carrying Newtonian fluid flow:

$${τ}_{rz} = - μ \frac{d {V}_{z}}{d r} \\ Newtonian Fluid \qquad [ Equation 2 ]$$

where τ_{rz} is shear stress in the radial (r) direction, normal to the axis of the tube (i.e. the z direction), and dV_{z}/dr is shear rate in the z direction with respect to r.

Equation 2 describes Newtonian fluids (and fluids in substantially Newtonian regimes), wherein viscosity (μ) does not vary as a function of shear rate. Non-Newtonian fluids, however, may become more viscous (“shear thickening” or “dilatant” fluids) or less viscous (“shear thinning” or “pseudoplastic” fluids”) as shear rate increases. A variety of empirical models have been developed to describe non-Newtonian fluid behavior, including the Bingham plastic, Ostwald-de Waele, Ellis, and Herschel-Bulkley models (described in greater depth below). FIG. 1 provides an illustration of shear stress as a function of shear rate for each of these models. For the most part these models have no theoretical basis, but each has been shown to be accurate describe a subset of non-Newtonian fluids.

The Bingham plastic model utilizes two viscosity-related parameters, “shear stress” and “apparent viscosity,” rather than a single Newtonian viscosity parameter. Bingham plastics do not flow unless subjected to sufficient shear stress. Once a critical shear stress τ₀ is exceeded, Bingham plastics behave in a substantially Newtonian fashion, exhibiting a constant apparent viscosity μ_{A}, as follows:

$${τ}_{rz} = {τ}_{0} - {μ}_{A} \frac{d {V}_{z}}{d r} \\ Bingham Plastic \qquad [ Equation 3 ]$$

Like the Bingham plastic model, the Ostwald-de Waele model provides a two-parameter description of fluid viscosity. The Ostwald-de Waele model is suited to “power law” fluids wherein shear stress is a power (rather than a linear) function of shear rate. Ostwald-de Waele fluids behave as follows:

$${τ}_{rz} = {{μ}_{A} [ - \frac{d {V}_{z}}{d r} ]}^{n} \\ Ostwald \text{-} de Waele Fluid \qquad [ Equation 4 ]$$

where μ_{A} is apparent viscosity, and n is a degree of deviation from Newtonian fluid behavior, with n<1 corresponding to a pseudoplastic fluid, and n>1 corresponding to a dilatant fluid.

The Ellis model uses three, rather than two, adjustable parameters to characterize fluid viscosity. The Ellis model describes shear rate as a function of shear stress, as follows:

$${ϕ}_{0} {τ}_{rz} + {{ϕ}_{1} ( {τ}_{rz} )}^{α} = - \frac{d {V}_{z}}{d r} \\ Ellis Fluid \qquad [ Equation 5 ]$$

where α, φ₀, and φ₁ are adjustable parameters. The Ellis model combines power law and linear components scaled by constants φ₀, and φ₁, with α>1 corresponding to a pseudoplastic fluid and α<1 corresponding to a dilatant fluid.

The Herschel-Bulkley fluid model combines the power law behavior of Ostwald-de Waele fluids with the rigidity of Bingham plastics below a critical shear stress, and uses three adjustable parameters. The Herschel-Bulkley model is particularly well suited to describing the slurries and muds handled in oil and gas drilling applications. According to the Herschel-Bulkley model,

$${τ}_{rz} = {τ}_{0} - {{μ}_{A} [ \frac{d {V}_{z}}{d r} ]}^{n} \\ Herschel \text{-} Bulkley Fluid \qquad [ Equation 6 ]$$

where τ₀ is critical shear stress, μ_{A} is apparent viscosity, and n is a degree of deviation from Newtonian fluid behavior as described above with respect to the Ostwald-de Waele fluid model (Equation 4).

Each of the models introduced above describes a class of non-Newtonian fluids which are not well handled by conventional industrial viscometers.

### SUMMARY

The present invention is directed toward a viscometer comprising a plurality of capillary tubes connected in series with a mass flow meter. The capillary tubes are smooth, straight, and unimpeded, and each has a different known, constant diameter. Differential pressure transducers sense differential pressure across measurement lengths of each capillary tube, and the mass flow meter senses fluid mass flow rate and fluid density. A data processor connected to the mass flow meter and the differential pressure transducers computes viscosity parameters of fluid flowing through the viscometer using non-Newtonian fluid models, based on the known, constant diameters and measurement lengths of each capillary tube, the sensed differential pressures across each measurement length, the fluid mass flow rate, and the fluid density. The present invention is further directed towards a method for determining these viscosity parameters using the aforementioned viscometer.

### BRIEF DESCRIPTION OF THE DRAWINGS

FIG. 1 is a graph illustrating shear stress as a function of shear rate according to several Newtonian and non-Newtonian fluid models.

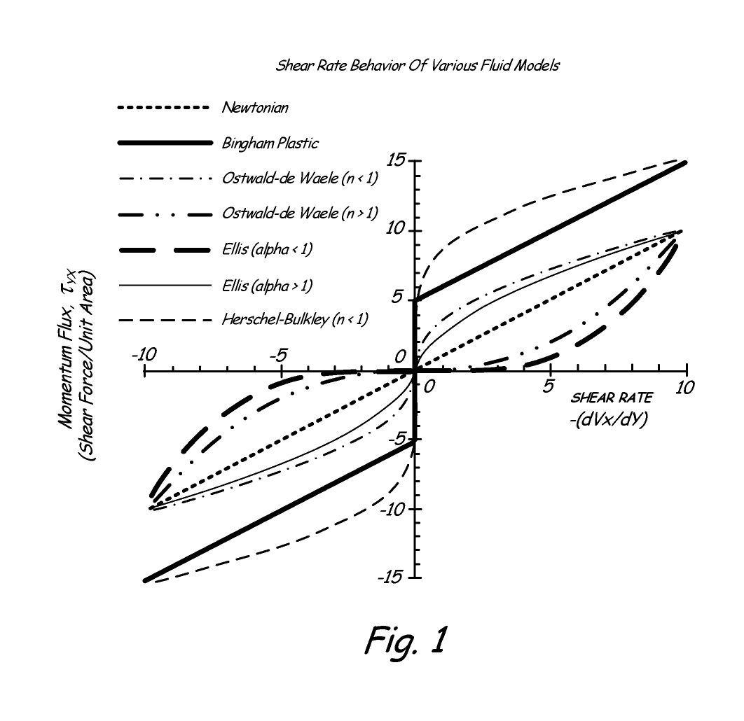

FIG. 2 is a schematic depiction of the viscometer of the present invention.

FIG. 3 is a flow chart of a method for computing fluid viscosity parameters of to the Herschel-Bulkley model.

### DETAILED DESCRIPTION

In general, the present invention relates to an in-line viscometer capable of handling any of a plurality of kinds of Newtonian or non-Newtonian fluids, including Bingham plastics and Ostwald-de Waele, Ellis, and Herschel-Bulkley fluids.

Viscometer Hardware

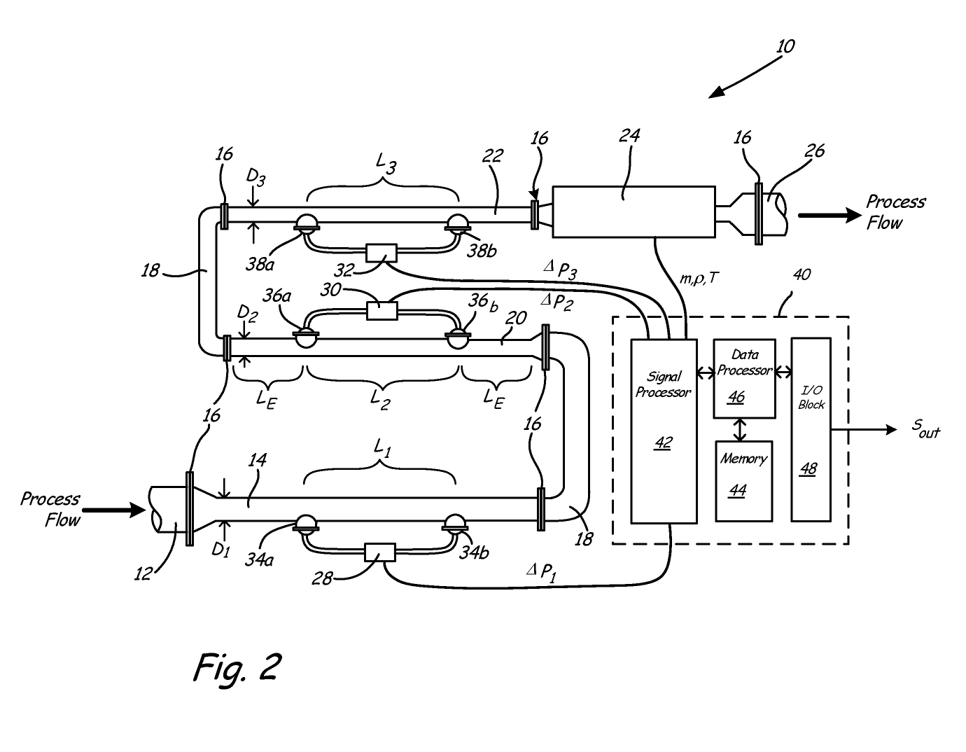

FIG. 2 depicts one illustrated embodiment of viscometer 10, comprising process flow inlet 12, first capillary tube 14, joint seals 16, connecting tubes 18, second capillary tube 20, third capillary tube 22, Coriolis mass flow meter 24, process flow outlet 26, first differential pressure transducer 28, second differential pressure transducer 30, third differential pressure transducer 32, first isolation diaphragms 34a and 34b, second isolation diaphragms 36a and 36b, third isolation diaphragms 38a and 38b, and process transmitter 40. Process transmitter 40 further comprises signal processor 42, memory 44, data processor 46, and input/output block 48.

Pursuant to the embodiment of FIG. 2, First, second, and third capillary tubes 14, 20, and 22 are smooth capillaries or tubes that allow fluid flow to equilibrate into a steady state shear distribution which does not vary as a function of axial position along measurement lengths L₁, L₂, and L₃. Measurement lengths L₁, L₂, and L₃ extend between isolation diaphragms 34a and 34b, seals 36a and 36b, and 38a and 38b, respectively. Measurement lengths L₁, L₂, and L₃ are located in substantially the mid portions of capillary tubes 14, 20, and 22. Each capillary tube 14, 20, and 22 has a different known diameter D₁, D₂, and D₃, respectively. Capillary tubes 14, 20, and 22 are connected in series with Coriolis mass flow meter 24, a conventional Coriolis effect device which measures fluid mass flow rate m, fluid density ρ, and fluid temperature T. Fluid enters first capillary tube 14 through process flow inlet 12, flows in series through second capillary tube 20, third capillary tube 22, and Coriolis mass flow meter 24, then exits viscometer 10 through process flow outlet 26. Process flow inlet 12 and process flow outlet 26 are connecting tubes or pipes which carry fluid from an industrial process, such as fluid polymer from a polymerization process or waste slurry from a drilling process. Viscometer 10 provides an in-line measurement of viscosity, rather than measuring the viscosity of a diverted fluid stream. This viscosity measurement takes the form of an output signal Sₒᵤₜ containing a number of viscosity parameters dependant on the fluid model used.

Although this Specification describes viscometer 10 as having three capillary tubes (14, 20, and 22), a person skilled in the art will recognize that additional capillary tubes may be needed to compute all viscosity parameters for fluid models with a large number of adjustable parameters. Similarly, fluid models with fewer adjustable parameters (such as the Bingham plastic and Ostwald-de Waele models, which have only two adjustable parameters, or the Newtonian fluid model, which has only one) may require fewer capillary tubes. Three capillary tubes are sufficient to compute all viscosity parameters for the fluid models considered herein. Although FIG. 2 depicts three capillary tubes, some embodiments of the present invention may use two capillary tubes, or four or more capillary tubes.

Pursuant to the embodiment of FIG. 2, connecting tubes 18 are pipes or tubes which join first capillary tube 14 to second capillary tube 20, and second capillary tube 20 to third capillary tube 22. Viscometer 10 is not sensitive to the shape or dimensions of connecting tubes 18, and some embodiments of viscometer 10 may lack one or more of the depicted connecting tubes, or include additional connecting tubes not shown in FIG. 2. In some embodiments, for instance, second capillary tube 20 may be connected directly (i.e. without any connecting tube 18) to first capillary tube 20 and/or third capillary tube 22. In other embodiments, additional connecting tubes may be interposed between process flow inlet 12 and first capillary tube 14, between third capillary tube 22 and Coriolis mass flow meter 24, and/or between Coriolis mass flow meter 24 and process flow outlet 26. Capillary tubes 14, 20, and 22 are formed of a rigid material such as copper, steel, or aluminum. The material selected for capillary tubes 14, 20, and 22 may depend on the process fluid, which in some applications can be caustic, abrasive, or otherwise damaging to some materials. Connecting tubes 18 may be formed of the same material as capillary tubes 14, 20, and 22, or may be formed of a less rigid material which is likewise resilient to the process fluid.

First, second, and third differential pressure transducers 28, 30, and 32 are conventional differential pressure devices such as capacitative differential pressure cells. Differential pressure transducers 28, 30, and 32 measure differential pressure across measurement lengths L₁, L₂, and L₃ of capillary tubes 14, 20, and 22, using isolation diaphragms 34, 36, and 38, respectively. Isolation diaphragms 34, 36, and 38 are diaphragms which transmit pressure from process fluid flowing through capillary tubes 14, 20, and 22, to differential pressure transducers 28, 30, and 32 via pressure lines such as closed oil capillaries. Isolation diaphragms 34a and 34b are positioned at opposite ends of measurement length L₁, isolation diaphragms 36a and 36b are positioned at opposite ends of measurement length L₂, and isolation diaphragms 34a and 34b are positioned at opposite ends of length L₃. Differential pressure transducers 28, 30, and 32 produce differential pressure signals ΔP₁, ΔP₂, and ΔP₃, which reflect pressure change across measurement lengths L₁, L₂, and L₃, respectively.

Although the present Specification describes sensing differential pressure directly via differential pressure cells, a person skilled in the art will understand that differential pressure could equivalently be measured in a variety of ways, including using two or more absolute pressure sensors positioned along each of measurement lengths L₁, L₂, and L₃ of capillary tubes 14, 20, and 22. The particular method of differential pressure sensing selected may depend on the specific application, and on process flow pressures.

In one embodiment, process transmitter 40 is an electronic device which receives sensor signals from Coriolis mass flow meter 24 and differential pressure transducers 28, 30, and 32, receives command signals from a remote monitoring/control room or center (not shown), computes process fluid viscosity based on one or more fluid models, and transmits this computed viscosity to the remote monitoring/control room. Process transmitter 40 includes signal processor 42, memory 44, data processor 46, and input/output block 48. Signal processor 44 is a conventional signal processor which collects and processes sensor signals from differential Coriolis mass flow meter 24 and pressure transducers 28, 30, and 32. Memory 44 is a conventional data storage medium such as a semiconductor memory chip. Data processor 46 is a logic-capable device such as a microprocessor. Input/output block 48 is a wired or wireless interface which transmits, receives, and converts analog or digital signals between process transmitter 40 and the remote monitoring/control room.

Signal processor 42 collects and digitizes differential pressure signals ΔP₁, ΔP₂, and ΔP₃ from differential pressure transducers 28, 30, and 32, and fluid mass flow rate m, fluid density ρ, and fluid temperature T from Coriolis mass flow meter 24. Signal processor 42 also normalizes and adjusts these values as necessary to calibrate each sensor. Signal processor 42 may receive calibration information or instructions from data processor 46 or input/output block 48 (via data processor 46).

Memory 44 is a conventional non-volatile data storage medium which is loaded with measurement lengths L₁, L₂, and L₃ and diameters D₁, D₂, and D₃. Memory 44 supplies these values to data processor 46 as needed. Memory 44 may also store temporary data during viscosity computation, and permanent or semi-permanent history data reflecting past viscosity information, configuration information, or the like. In some embodiments, memory 44 may be loaded with a plurality of algorithms for computing viscosity of fluids according to multiple models (e.g. Newtonian, Bingham plastic, Ostwald-de Waele, Ellis, or Herschel-Bulkley). In such embodiments, memory 44 may further store a model selection designating one of these algorithms for use at the present time. This model selection can be provided by a user or remote controller via input/output block 48, or may be made by data processor 46. Some embodiments of process transmitter 40 may only be configured to handle a single fluid model.

Data processor 46 computes one or more adjustable viscosity parameters according to at least one fluid model introduced above, using measurement lengths L₁, L₂, and L₃ and diameters D₁, D₂, and D₃ from memory 44, and differential pressures ΔP₁, ΔP₂, and ΔP₃, fluid mass flow rate m, fluid density ρ, and fluid temperature T from signal processor 42. The particular adjustable viscosity parameters computed depend on the fluid model selected, as discussed in greater detail below with respect to each model. Using the Bingham plastic model, for instance, data processor 46 would compute shear stress τ₀ and apparent viscosity μ_{A}. As noted above, models with only two adjustable parameters (e.g. the Bingham plastic and Ostwald-de Waele models) will require data for only two of the three capillary tubes provided. In such cases, L₃, D₃, and ΔP₃, for instance, may be disregarded. Data processor 46 assembles all computed viscosity parameters into an output signal Sₒᵤₜ, which input/output block 48 transmits to the remote controller.

Input/output block 48 transmits output signal Sₒᵤₜ to the remote controller, and receives commands from the remote controller and any other external sources. Where data processor 46 provides output signal Sₒᵤₜ in a format not appropriate for transmission, input/output block 48 may also convert Sₒᵤₜ into an acceptable analog or digital format. Some embodiments of input-output block 48 communicate with the remote controller via a wireless transceiver, while others may use wired connections.

Data processor 46 computes viscosity parameters for a selected fluid model using variations on the Hagan-Poiseuille equation. For Newtonian fluids, the Hagan-Poiseuille equation states that:

$$\frac{m}{ρ} = \frac{π ( Δ P ) {( D / 2 )}^{4}}{8 μ L} \\ Newtonian Hagan \text{-} Poiseuille \qquad [ Equation 7 ]$$

where m is fluid mass flow rate, ρ is fluid density, μ is viscosity, and ΔP is a pressure differential across a single capillary of length L and diameter D. By measuring differential pressure across measurement lengths L₁, L₂, and L₃ of first, second, and third capillary tubes 14, 20, 22 (each of which has a different known diameter D), viscometer 10 is able solve non-Newtonian variants of the Hagan-Poiseuille equation with multiple viscosity parameters, as described in greater detail below.

The Hagan-Poiseuille equation assumes fully developed, steady-state, laminar flow through a round cross-section constant-diameter capillary tube with no slip between fluid and the capillary wall. To ensure that all of these assumptions hold true, capillary tubes 14, 20, and 22 must be entirely straight, smooth, and devoid of any features which might disrupt steady-state flow. In addition, capillary tubes 14, 20, and 22 must be long enough that changes in tube geometry near the ends of capillary tubes 14, 20, and 22 (e.g. turns in connecting tubes 18, or changes in tube diameter) have negligible effect on the behavior of fluid within passing through measurement lengths L₁, L₂, and L₃ of these capillary tubes. Accordingly, each capillary tube extends a buffer length L_{E} to either end of each measurement length, to minimize the effect of such changes in geometry. This buffer length L_{E} is:

L_{E}≧0.035*D*[Re] Buffer Length [Equation 7]

where D is the diameter of the appropriate capillary tube, and [Re] is the Reynolds number of the process fluid within the capillary tube. [Re] is a dimensionless quantity which provides a measure of turbulence within the flowing process fluid. [Re] can be calculated for each fluid model as known in the art, but is in any case less than 2100 for laminar flow. Generally, each capillary tube 14, 20, and 22 has a total length L_{Tot} greater than or equal to L+2L_{E}, i.e. L_{Tot1}≧L₁+2L_{E1}=L₁+0.07D₁[Re]₁, L_{Tot2}≧L₂+2L₂=+0.07D₂[Re]₂, etc.

Bingham plastics and Herschel-Bulkley fluids will not flow if shear stress does not exceed a critical shear stress τ₀. To carry such fluids, capillary tubes 14, 20, and 22 must be constructed such that

$${τ}_{0} < \frac{D * Δ {P}_{total}}{4 {L}_{total}} \qquad [ Equation 8 ]$$

where D is the diameter of the capillary tube, Lₜₒₜₐₗ is the total length of the capillary tube, and ΔPₜₒₜₐₗ is the total pressure drop across the capillary tube.

Fluid Model Solutions

As noted above, in some embodiments memory 44 may store algorithms for solving for parameters of various fluid models, based on measurement lengths L₁, L₂, and L₃, diameters D₁, D₂, and D₃, differential pressures ΔP₁, ΔP₂, and ΔP₃, fluid mass flow rate m, fluid density ρ, and fluid temperature T. Alternatively, data processor 46 may be hardwired to solve for parameters of one or more fluid models. These parameters are then transmitted to the remote monitoring/control room as a part of output signal Sₒᵤₜ, and may be stored locally or provided to other devices or users in some embodiments. Although particular parameters, and the algorithms used to solve for them, vary from model to model, all parameters of all models considered herein can be computed using no more than three capillary tubes (i.e. capillary tubes 14, 20, and 22) of known diameter and measurement length. A person skilled in the art will understand that, although the Newtonian, Bingham plastic, Ostwald-de Waele, Ellis, and Herschel-Bulkley models are discussed in detail herein, other fluid models might additionally or alternatively be utilized, with viscometer 10 incorporating additional capillary tubes as needed for models having a larger number of free parameters.

For Bingham plastics, the Hagan-Poiseuille equation becomes:

$$\frac{m}{ρ} = \frac{πΔ {P [ D / 2 ]}^{4}}{8 {μ}_{A} L} ( 1 - \frac{4}{3} ( {τ}_{0} / {τ}_{R} ) + \frac{1}{3} {( {τ}_{0} / {τ}_{R} )}^{4} ) ; \\ where \\ {τ}_{R} = \frac{Δ P [ D / 2 ]}{2 L} , \\ i . e . \\ {τ}_{1} = \frac{Δ {P}_{1} [ {D}_{1} / 2 ]}{2 {L}_{1}} , \\ {τ}_{2} = \frac{Δ {P}_{2} [ {D}_{2} / 2 ]}{2 {L}_{2}} , \\ etc . \\ Bingham Plastic Hagan Poiseuille \qquad [ Equations 9 ]$$

for the domain within which the Bingham plastic model is continuous (i.e. for τ_{R}>τ₀, under which conditions Bingham plastics flow). As stated previously, m is fluid mass flow rate, ρ is fluid density, D is capillary tube diameter, L is measurement length, τ₀ is the critical shear stress required for fluidity, and μ_{A} is the apparent viscosity of the Bingham plastic for τ>τ₀.

ΔP is a linear function of τ_{R}, such that:

$$\begin{matrix}Δ P = {C}_{1} {τ}_{R} + Δ {vP}_{0} ; \\ where & [ Equation 10 ] \\ {C}_{1} = \frac{Δ {P}_{2} - Δ {P}_{1}}{{τ}_{2} - {τ}_{1}} \\ and & [ Equation 11 ] \\ Δ {P}_{0} = Δ {P}_{1} - {C}_{1} {τ}_{1} & [ Equation 12 ]\end{matrix}$$

Accordingly, it is possible to solve for the two viscosity parameters of the Bingham plastic model—critical shear stress τ₀ and apparent viscosity μ_{A}—by substituting into Equations 9, which yields:

$$\begin{matrix}{τ}_{0} = \frac{Δ {P}_{0} [ {D}_{1} / 2 ]}{2 {L}_{1}} = \frac{{D}_{1}}{4 {L}_{1}} ( Δ {P}_{1} - {C}_{1} {τ}_{1} ) ; \\ and & [ Equation 13 ] \\ {μ}_{A} = \frac{Δ {{P}_{1} [ {D}_{1} / 2 ]}^{4} πρ}{8 {mL}_{1}} ( 1 - \frac{4}{3} ( {τ}_{0} / {τ}_{1} ) + \frac{1}{3} {( {τ}_{0} / {τ}_{1} )}^{4} ) & [ Equation 14 ]\end{matrix}$$

When the model selection stored in memory 44 designates the Bingham plastic model (or in embodiments wherein data processor 46 is hardcoded for Bingham plastics), data processor 46 computes τ₀ and μ_{A} using this solution.

For Ostwald-de Waele fluids, the Hagan-Poiseuille equation becomes:

$$\frac{m}{ρ} = \frac{{π [ D / 2 ]}^{3}}{3 n + 1} {( \frac{[ D / 2 ] Δ P}{2 {μ}_{A} L} )}^{\frac{1}{n}} \\ Ostwald \text{-} de Waele Hagan \text{-} Poiseuille \qquad [ Equation 15 ]$$

where m is fluid mass flow rate, ρ is fluid density, D is capillary tube diameter, L is measurement length, μ_{A} is apparent viscosity, and n is a degree of deviation from Newtonian fluid behavior, as described previously. Substituting measurement lengths L, differential pressures ΔP, and capillary tube diameters D for two capillary tubes (which may be any of capillary tubes 14, 20, or 22) yields two equations:

$$\begin{matrix}\frac{m}{ρ} = \frac{{π [ {D}_{1} / 2 ]}^{3}}{3 n + 1} {( \frac{[ {D}_{1} / 2 ] Δ {P}_{1}}{2 {μ}_{A} {L}_{1}} )}^{\frac{1}{n}} \\ \frac{m}{ρ} = \frac{{π [ {D}_{2} / 2 ]}^{3}}{3 n + 1} {( \frac{[ {D}_{2} / 2 ] Δ {P}_{2}}{2 {μ}_{A} {L}_{2}} )}^{\frac{1}{n}}\end{matrix} \} \qquad [ Equations 16 ]$$

which can be solved simultaneously for n and μ_{A}, yielding:

$$\begin{matrix}n = \frac{ln ( {D}_{1} Δ {P}_{1} {L}_{2} ) - ln ( {D}_{2} Δ {p}_{2} {L}_{1} )}{3 ln ( {D}_{2} / {D}_{1} )} & [ Equation 17 ] \\ {μ}_{A} = \frac{[ {D}_{1} / 2 ] Δ {P}_{1}}{2 {{L}_{1} ( m ( 3 n + 1 ) / {πρ [ {D}_{1} / 2 ]}^{3} )}^{n}} & [ Equation 18 ]\end{matrix}$$

When the model selection stored in memory 44 designates the Ostwald-de Waele model (or in embodiments wherein data processor 46 is hardcoded for the Ostwald-de Waele model), data processor 46 computes n and μ_{A} using this solution. The Ostwald-de Waele model and the Bingham plastic model have only two free parameters, and thus require only two capillary tubes for a complete solution. Consequently, embodiments of viscometer 10 intended only to utilize these and other two-dimensional models could dispense with third capillary tube 22. Alternatively, viscometer 10 separately compute fluid parameters using more than one combination of capillary tubes (e.g. capillary tubes 14 and 20, capillary tubes 14 and 22, and capillary tubes 20 and 22), and compare the results of these computations—which should be substantially identical—to verify that viscometer 10 is correctly calibrated and functioning.

The Ellis and Herschel-Bulkley models utilize three viscosity parameters. Consequently, all three capillary tubes 14, 20 and 22 of the embodiment depicted in FIG. 2 are needed to solve for these parameters, and more than three capillary tubes would be required to produce redundant solutions for verification. For Ellis fluids, the Hagan-Poiseuille equation becomes:

$$\frac{m}{ρ} = \frac{{πϕ}_{0} Δ {P [ D / 2 ]}^{4}}{8 L} + \frac{{{πϕ}_{1} [ D / 2 ]}^{3}}{α + 3} {( \frac{[ D / 2 ] Δ P}{2 L} )}^{α} \\ Ellis Hagan \text{-} Poiseuille \qquad [ Equation 19 ]$$

where m is fluid mass flow rate, ρ is fluid density, D is capillary tube diameter, L is measurement length, and α, φ₀, and φ₁ are adjustable parameters of the Ellis model as described previously. Substituting measurement lengths L, differential pressures ΔP, and capillary tube diameters D for each capillary tubes 14, 20 and 22 yields three equations:

$$\begin{matrix}\frac{m}{ρ} = \frac{{πϕ}_{0} Δ {{P}_{1} [ {D}_{1} / 2 ]}^{4}}{8 {L}_{1}} + \frac{{{πϕ}_{1} [ {D}_{1} / 2 ]}^{3}}{α + 3} {( \frac{[ {D}_{1} / 2 ] Δ {P}_{1}}{2 {L}_{2}} )}^{α} \\ \frac{m}{ρ} = \frac{{πϕ}_{0} Δ {{P}_{2} [ {D}_{2} / 2 ]}^{4}}{8 {L}_{2}} + \frac{{{πϕ}_{1} [ {D}_{2} / 2 ]}^{3}}{α + 3} {( \frac{[ {D}_{2} / 2 ] Δ {P}_{2}}{2 {L}_{2}} )}^{α} \\ \frac{m}{ρ} = \frac{{πϕ}_{0} Δ {{P}_{3} [ {D}_{3} / 2 ]}^{4}}{8 {L}_{3}} + \frac{{{πϕ}_{1} [ {D}_{3} / 2 ]}^{3}}{α + 3} {( \frac{[ {D}_{3} / 2 ] Δ {P}_{3}}{2 {L}_{3}} )}^{α}\end{matrix} \} \qquad [ Equations 20 ]$$

There is no closed-form analytic solution for the system of equations 20. If the model selection stored in memory 44 designates the Ellis model (or if data processor 46 is hardcoded for the Ellis model), data processor 46 can simultaneously solve equations 20 for α, φ₀, and φ₁ using any of a plurality of conventional iterative computational techniques.

For Herschel-Bulkley fluids, the Hagan-Poiseuille equation becomes:

$$\frac{Δ P}{L} = {{{\frac{4 {μ}_{A}}{D} [ \frac{32 m}{ρπ {D}^{3}} ]}^{n} [ \frac{3 n + 1}{4 n} ]}^{n} [ \frac{1}{1 - X} ] [ \frac{1}{1 - aX - {bX}^{2} - cX} ]}^{n} ; \\ with \\ a = \frac{1}{2 n + 1} ; \\ b = \frac{2 n}{( n + 1 ) ( 2 n + 1 )} ; \\ c = \frac{2 {n}^{2}}{( n + 1 ) ( 2 n + 1 )} ; \\ and \\ X = \frac{4 L {τ}_{0}}{D Δ P} ; \\ i . e . \\ {X}_{1} = \frac{4 {L}_{1} {τ}_{0}}{{D}_{1} Δ {P}_{1}} ; \\ {X}_{2} = \frac{4 {L}_{2} {τ}_{0}}{{D}_{2} Δ {P}_{2}} ; \\ etc . \\ Herschel \text{-} Bulkley Hagan \text{-} Poiseuille \qquad [ Equations 21 ]$$

where m is fluid mass flow rate, ρ is fluid density, D is capillary tube diameter, L is measurement length, τ₀ is critical shear stress, μ_{A} is apparent viscosity, and n is a degree of deviation from Newtonian fluid behavior. Substituting measurement lengths L, differential pressures ΔP, and capillary tube diameters D for each capillary tubes 14, 20 and 22 yields three equations:

$$[ Equations 22 ] \\ \begin{matrix}\frac{Δ {P}_{1}}{{L}_{1}} = {{{\frac{4 {μ}_{0}}{{D}_{1}} [ \frac{32 m}{ρπ {D}_{1}^{3}} ]}^{n} [ \frac{3 n + 1}{4 n} ]}^{n} [ \frac{1}{1 - {X}_{1}} ] [ \frac{1}{1 - {aX}_{1} - {bX}_{1}^{2} - {cX}_{1}^{3}} ]}^{n} \\ \frac{Δ {P}_{2}}{{L}_{2}} = {{{\frac{4 {μ}_{0}}{{D}_{2}} [ \frac{32 m}{ρπ {D}_{2}^{3}} ]}^{n} [ \frac{3 n + 1}{4 n} ]}^{n} [ \frac{1}{1 - {X}_{2}} ] [ \frac{1}{1 - {aX}_{2} - {bX}_{2}^{2} - {cX}_{2}^{3}} ]}^{n} \\ \frac{Δ {P}_{3}}{{L}_{3}} = {{{\frac{4 {μ}_{0}}{{D}_{3}} [ \frac{32 m}{ρπ {D}_{3}^{3}} ]}^{n} [ \frac{3 n + 1}{4 n} ]}^{n} [ \frac{1}{1 - {X}_{3}} ] [ \frac{1}{1 - {aX}_{3} - {bX}_{3}^{2} - {cX}_{3}^{3}} ]}^{n}\end{matrix} \}$$

As with the Ellis model, there is no closed-form analytic solution for the system of equations 22. If the model selection stored in memory 44 designates the Herschel-Bulkley model (or if data processor 46 is hardcoded for the Herschel-Bulkley model), data processor 46 solves equations 22 for τ₀, μ_{A}, and n computationally. Because the Herschel-Bulkley model combines the power law behavior of Ostwald-de Waele fluids with the critical shear stress discontinuity of Bingham plastics, a particularly efficient computational simultaneous solution of equations 22 uses the previously discussed analytic solutions to the Ellis and Bingham plastic models to iteratively improve upon estimates of τ₀, μ_{A}, and n.

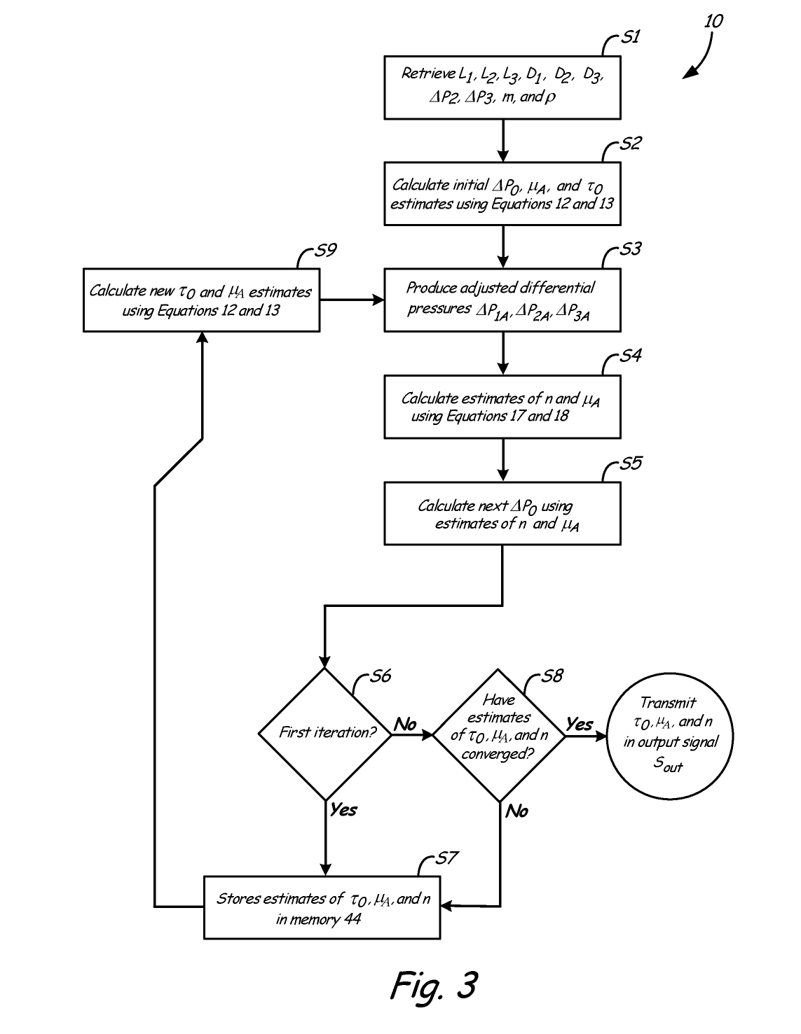

FIG. 3 is a flow chart of method 100, which provides an iterative computational solution to Equations 22. First, data processor 46 retrieves measurement lengths L₁, L₂, and L₃, and capillary tube diameters D₁, D₂, D₃ from memory 44, and differential pressures ΔP₁, ΔP₂, and ΔP₃, fluid mass flow rate m, and fluid density ρ from Coriolis mass flow meter 24. (Step S1). Next, data processor 46 approximates process fluid flow as a Bingham plastic and solves for initial values of ΔP₀, μ_{A}, and τ₀ using Equations 12 and 13, respectively. (Step S2). Data processor 46 then produces adjusted differential pressures ΔP_{1A}=ΔP₁−ΔP₀, ΔP_{2A}=ΔP₂−ΔP₀ and ΔP_{3A}=ΔP₃−ΔP₀. (Step S3). Substituting adjusted differential pressures ΔP_{1A}, ΔP_{2A}, and ΔP_{3A} for measured differential pressures ΔP₁, ΔP₂, and ΔP₃ allows data processor 46 to approximate process fluid as an Ostwald-de Waele fluid. Data processor 46 solves for n and μ_{A} with Equations 17 and 18, respectively, with all possible combinations of ΔP_{1A}, ΔP_{2A}, and ΔP_{3A} (i.e. ΔP_{1A} and ΔP_{2A}, ΔP_{1A} and ΔP_{3A}, and ΔP_{2A} and ΔP_{3A}), and utilizes the mean of these solution values as n and μ_{A}. (Step S4). Data processor 46 then calculates a next estimate of ΔP₀ using these values of n and μ_{A}. (Step S5). On the first iteration of method 100, (checked in Step S6) data processor 46 then stores the current estimates of τ₀, μ_{A}, and n in memory 44. (Step S7). On subsequent iterations (checked in Step S6), data processor 46 compares the latest estimates of τ₀, μ_{A}, and n to stored values to determine whether τ₀, μ_{A}, and n have converged. (Step S8). If the differences between stored values and the latest estimates are negligible (or, more generally, if these differences fall below a predefined threshold), data processor 46 passes the latest values of τ₀, μ_{A}, and n to input/output block 48, which transmits output signal Sₒᵤₜ, to the remote controller and any other intended recipients. (Step S9). Otherwise, processor 46 stores the latest estimates of τ₀, μ_{A}, and n in memory 44 (Step S7), and computes new estimates of τ₀ and μ_{A} using equations 12 and 13, and the newly ΔP₀ estimate of Step S5. (Step S10). These new estimates of τ₀ and μ_{A} are used to produce new estimates of n and μ_{A} from Equations 17 and 18, as method 100 repeats itself.

By iteratively alternating between approximating a Herschel-Bulkley fluid as a Bingham plastic and an Ostwald-de Waele fluid, method 100 is able to rapidly converge upon a highly accurate computational solution to Equations 22. A person skilled in the art will understand, however, that other computational methods could also be used to determine critical shear stress τ₀, apparent viscosity μ_{A}, and degree of deviation from Newtonian behavior n.

The viscosities of many fluids are temperature-dependant. For industrial processes which operate at substantially constant temperature, this temperature dependence may typically be ignored Likewise, some applications may require that viscosity be measured at a fixed temperature. To accomplish this, process fluid may be pumped to a heat exchanger, or viscometer 10 maybe mounted in a regulated constant temperature bath. Although the particular details of viscosity temperature-dependence are not discussed herein, data processor 46 may receive temperature readings from within viscometer 10 for applications wherein considerable temperature variation is expected. In particular, the present Specification has described Coriolis mass flow meter 24 as providing a measurement of fluid temperature T. A person having ordinary skill in the art will recognize that temperature sensors may alternatively or additionally be integrated into other locations within viscometer 10.

As noted above, viscometer 10 may contain more or fewer capillary tubes than the three (capillary tubes 14, 20, and 22) described herein. In particular, embodiments of viscometer 10 suited for two-dimensional fluid models may feature only two capillary tubes, while embodiments suited for four (or more)—dimensional fluid models will require additional capillary tubes. In addition, some embodiments of viscometer 10 may dispense with one capillary tube by measuring a pressure drop across Coriolis mass flow meter 24. Because Coriolis mass flow meter 24 does not provide the perfectly straight, smooth, and unimpeded fluid path required to ensure steady-state laminar fluid flow, the Hagan-Poiseuille equation would not accurately describe fluid behavior through such a system, and computed viscosity parameter accuracy would accordingly suffer. For may applications, however, a slight decrease in accuracy may be an acceptable trade for making viscometer 10 less expensive and more compact.

Viscometer 10 can be used to determine the viscosity of Newtonian fluids, but more significantly allows viscosity parameters to be measured with high accuracy for various non-Newtonian fluid models, including but not limited to the Bingham plastic, Ellis, Ostwald-de Waele, and Herschel-Bulkley models. As described above, process transmitter 40 may be manufactured with the capacity to handle multiple fluid models, allowing viscometer 10 to be adapted to a range of fluid applications by specifying a particular model, without replacing any hardware. Viscometer 10 operates in-line with industrial processes stream, and therefore need not divert process fluid away from a process stream in order to produce an accurate measure of process fluid viscosity.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A viscometer comprising:
a first capillary tube having a first diameter D₁ and a first tube length L_{Tot1};
a first differential pressure transducer operating across a first measurement length L₁ of the first capillary tube to sense a first differential pressure ΔP₁, the first measurement length L₁ extending across a smooth, straight, and unimpeded portion of the first capillary tube configured to produce steady state laminar flow;
a second capillary tube fluidly connected in series after the first capillary tube and having a second diameter D₂≠D₁ and a second tube length L_{Tot2};
a second differential pressure transmitter operating across a second measurement length L₂ of the second capillary tube to sense a second differential pressure ΔP₂, the second measurement length L₂ extending across a smooth, straight, and unimpeded portion of the second capillary tube configured to produce steady state laminar flow;
a mass flow meter fluidly connected in series after the second capillary tube, and capable of sensing fluid density ρ and fluid mass flow rate m; and
a processor in data communication with the mass flow meter, and capable of computing viscosity parameters of fluid flowing through the first capillary tube, the second capillary tube, and the mass flow meter using non-Newtonian fluid models, based on D₁, D₂, L₁, L₂, ΔP₁, ΔP₂, ρ, and m.

2. The viscometer of claim 1, wherein the processor is also capable of computing the Newtonian viscosity of fluid flowing through the first capillary tube, the second capillary tube, the second capillary tube, an the mass flow meter based on D₁, D₂, L₁, L₂, ΔP₁, ΔP₂, ρ, and m.

3. The viscometer of claim 1, wherein the first tube length L_{Tot1} is greater than or equal to L₁+0.07D₁ [Re]₁, and L_{Tot2} is greater than or equal to L₂+0.07D₂ [Re]₂, where [Re]₁ is the Reynolds number of fluid flowing through the first capillary tube and [Re]₂ is the Reynolds number of fluid flowing through the second capillary tube.

4. The viscometer of claim 1, wherein the processor is configured to model the fluid as a Bingham plastic, and wherein the computed viscosity parameters are an apparent viscosity μ_{A} and a critical shear stress τ₀.

5. The viscometer of claim 1, wherein the processor is configured to model the fluid as an Ostwald-de Waele fluid, and wherein the computed viscosity parameters are an apparent viscosity μ_{A} and an exponential degree of deviation from Newtonian behavior n.

6. The viscometer of claim 1, further comprising:
a third capillary tube fluidly connected in series after the first and second capillary tubes, and having a third diameter D₃≠D₁ or D2 and a third tube length L_{Tot3}; and
a third differential pressure transmitter operating across a third measurement length L₃ of the third capillary tube to sense a third differential pressure ΔP₃, the third measurement length L₃ extending across a smooth, straight, and unimpeded portion of the third capillary tube configured to produce steady state laminar flow; and
wherein the processor computes viscosity parameters based on D₃, L₃ and ΔP₃, in addition to D₁, D₂, L₁, L₂, ΔP₁, ΔP₂, ρ, and m.

7. The viscometer of claim 6, wherein the processor is configured to model the fluid as an Ellis fluid with, and wherein the computed viscosity parameters are α, φ₀, and φ₁ of the Ellis fluid equation
$${ϕ}_{0} {τ}_{rz} + {{ϕ}_{1} ( {τ}_{rz} )}^{α} = - \frac{d {V}_{z}}{d r} .$$

8. The viscometer of claim 6, wherein the processor is configured to model the fluid as a Herschel-Bulkley fluid, and wherein the computed viscosity parameters are a critical shear stress τ₀, an apparent viscosity μ_{A}, and an exponential degree of deviation from Newtonian behavior n.

9. The viscometer of claim 9, wherein the processor is configured to compute τ₀, μ_{A}, and n by iterating alternately between solving for τ₀ and μ_{A} using a Bingham plastic model, and solving for μ_{A} and n using a Ostwald-de Waele model.

10. The viscometer of claim 1, further comprising a temperature sensor which produces a sensed fluid temperature used by the processor to compute the viscosity parameters.

11. The viscometer of claim 1, wherein the mass flow meter is a Coriolis effect mass flow meter.

12. The viscometer of claim 11, wherein one of the first capillary tube and the second capillary tube is incorporated into the Coriolis effect mass flow meter.

13. A method for characterizing viscosity of a fluid, the method comprising:
sensing a first differential pressure of the fluid across a first length of a smooth, straight, and unimpeded first capillary having a constant first diameter;
sensing a second differential pressure of the fluid across a second length of a smooth, straight, and unimpeded second capillary fluidly connected in series with the first capillary, and having a constant second diameter;
sensing fluid density and fluid mass flow rate at a mass flow meter fluidly connected in series with the second capillary;
computing adjustable viscosity parameters of a non-Newtonian fluid model using the first and second capillary lengths, the first and second diameters, the sensed first and second differential pressures, the fluid density, and the fluid mass flow rate; and
outputting the computed adjustable viscosity parameters in an output signal.

14. The method of claim 13, wherein the non-Newtonian fluid model is a Bingham plastic model, and wherein solving for adjustable viscosity parameters comprises solving for apparent viscosity μ_{A} and a critical shear stress τ₀.

15. The method of claim 13, wherein the non-Newtonian fluid model is an Ostwald-de Waele model, and wherein solving for adjustable viscosity parameters comprises solving for apparent viscosity μ_{A} and an exponential degree of deviation from Newtonian behavior n.

16. The method of claim 13, wherein the non-Newtonian fluid model is an Ellis model, and wherein solving for adjustable viscosity parameters comprises solving for τ, τ₀, and φ₁ of the Ellis fluid equation
$${ϕ}_{0} {τ}_{rz} + {{ϕ}_{1} ( {τ}_{rz} )}^{α} = - \frac{d {V}_{z}}{d r} .$$

17. The method of claim 13, wherein the non-Newtonian fluid model is a Herschel-Bulkley model, and wherein solving for adjustable viscosity parameters comprises solving for critical shear stress τ₀, an apparent viscosity μ_{A}, and an exponential degree of deviation from Newtonian behavior n.

18. The viscometer of claim 17, wherein solving for τ₀, μ_{A}, and comprises iterating alternately between solving for τ₀ and μ_{A} using a Bingham plastic model, and solving for μ_{A} and n using a Ostwald-de Waele model.

19. A viscometer comprising:
first capillary tube coupled to a first differential pressure sensor configured to sense a first differential pressure across a steady state region of the first capillary tube;
a second capillary tube fluidly connected in series with the first capillary tube, and coupled to a second differential pressure sensor configured to sense a second differential pressure across a steady state region of the second capillary tube;
a sensor device fluidly connected in series with the first and second capillary tube, and capable of sensing fluid mass flow rate and fluid density; and
a data processor which computes a plurality of viscosity parameters of fluid passing through the first capillary tube, the second capillary tube, and the sensor device based on the mass flow rate, the density, the differential pressure across each capillary tube, and the dimensions of each capillary tubes.

20. The viscometer of claim 19, wherein the plurality of viscosity parameters are free parameters of a non-Newtonian fluid model selected from the group comprising Bingham plastic, Ostwald-de Waele, an Ellis, or a Herschel-Bulkley fluid models.

21. The viscometer of claim 20, further comprising a memory configured to store:
a plurality of algorithms for computing the viscosity parameters using any of a plurality of the group of fluid models; and
a fluid model selection designating one of the plurality of algorithms to be used to compute the viscosity parameters.

22. The viscometer of claim 21, wherein the data processor is a part of a process transmitter configured to report the viscosity parameters to a central controller.

23. The viscometer of claim 22, wherein the viscometer is configured to fit in-line into an industrial process flow.
